(19) United States
(12) Patent Application Publication
(10) Pub. No.: US 2004/0000624 A1
(43) Pub. Date: Jan. 1, 2004

(54) Stanchion; Equipment assembly; and, method

(76) Inventors: Jared D. Blaisdell, Bloomington, MN (US); Daniel S. Gauer, Lakeville, MN (US)

Correspondence Address: MERCHANT & GOULD PC, P.O. BOX 2903, MINNEAPOLIS, MN, 55402-0903, US

(21) Appl. No.: 10/435,343

(22) Filed: May 9, 2003

Related U.S. Application Data
(60) Provisional application No. 60/379,454, filed on May 10, 2002.

(51) Int. Cl. B60K 13/04; F16M 3/00

(52) U.S. Cl. 248/647; 180/309

(57) ABSTRACT

A stanchion arrangement is provided. The stanchion arrangement is especially configured for use on a moving vehicle, such as a truck, to support equipment such as a muffler assembly. The preferred stanchion arrangement includes at least two, for example four, tubular components, secured to one another. An arrangement or assembly including a stanchion arrangement in combination with equipment such as a muffler is provided. Also methods of assembly and use are provided.

### CROSS-REFERENCE TO RELATED APPLICATION

A claim of priority for the present application is made to U.S. provisional application No. 60/379,454 filed May 10, 2002. The complete disclosure of application No. 60/379,454 is incorporated herein by reference. The current disclosure does contain additional information to that provided in the No. 60/379,454 provisional application.

### FIELD OF THE INVENTION

The present disclosure concerns stanchions or masts for supporting equipment on vehicles. In a preferred embodiment, it concerns a muffler mast or stanchion usable to support a muffler in a vertical orientation on a vehicle such as a truck. The disclosure also concerns assemblies comprising equipment such as a muffler, in combination with a stanchion according to the disclosure; and, methods of use.

### BACKGROUND OF THE INVENTION

Many trucks and other vehicles must have equipment such as vertical mufflers mounted thereon. For a Class 8 truck, a muffler, for example, generally weighs at least 20 pounds (9 kg.). Due to its length, typically 45 to 65 inches (1.14-1.65 m.), in many instances a muffler (or similar equipment) needs to be securely mounted in a vertical orientation. For many support arrangements, tie rods or other upper supports have been necessary, to manage secure support, even under vibrations during operation.

Improvements have been sought.

### SUMMARY

According to the present disclosure a stanchion assembly is provided. The assembly includes a stanchion usable to support equipment on a moving vehicle, such as a truck. In general the stanchion is configured to extend vertically, from a framework of the truck or other vehicle. The stanchion is usable to support, for example, a vertical muffler assembly or an air cleaner assembly. The figures, as an example, show use to support a muffler.

The preferred stanchion disclosed comprises multiple (i.e., at least two) tubular supports. By “tubular” in this context, it is meant that preferably each of at least two supports comprises a member having a longitudinal channel therein. In some embodiments more than two supports can be used, and each can be tubular. However, in alternate embodiments at least two supports will be tubular and others can have a different configuration.

In typical applications each one of a first two of the at least two tubular supports includes at least two bends therein. A preferred configuration is shown.

In a typical embodiment, two, vertical, tubular, side, supports are spaced by a center support structure. The center support structure may include more than one structural piece. For example, in the embodiments shown, the center structure comprises two structural pieces.

Preferred stanchions are configured to have a relatively small base. Preferably all support tubes which form the stanchion are configured to define, together, a total base perimeter of no greater than 30 inches (76 cm.). Typically they define a base perimeter of no greater than 24 inches (61 cm.).

The particular, preferred, embodiment depicted uses four tubular supports comprising: first and second side supports each having two bends; a long first, typically back side, center support; and, a short or short beam, typically front side, second center support. For the particular embodiment shown, the side supports have, as a result of the two bends, an open z configuration, although alternatives are possible. Also, for the particular embodiment shown, the long center support has, as a result of one bend, an open L configuration; and, the short beam center support has no bends and is thus straight, although alternatives are possible.

The components are configured for convenient manufacturing. For example, tubular steel can be used. The components can be readily welded or mechanically fastened together, to form the stanchion.

Also provided is a stanchion assembly or equipment assembly comprising the stanchion and supported equipment, such as a muffler. Convenient bracket arrangements to support a muffler, are provided.

The present disclosure also concerns methods of supporting equipment such as a muffler, or other vehicle equipment, comprising supporting the equipment on a stanchion construction without the use of an upper support equipment or construction such as upper tie-rods or upper dampeners, but rather only with mounting occurring in a base region of the stanchion (with or without a lower dampener). In a typical application involving a muffler, the stanchion weight will be at least 20 lbs. (about 9 kg.) typically at least 40 lbs. (about 18.1 kg.), and the supported equipment will weigh at least 20 lbs. (about 9 kg.). Examples are described.

The present disclosure also concerns preferred performance criteria, and design approaches and criteria.

### BRIEF DESCRIPTION OF THE DRAWINGS

FIG. 1 is a front perspective view of a mast or stanchion according to the present disclosure.

FIG. 2 is a rear perspective view of the stanchion of FIG. 1.

FIG. 3 is a side elevational view of the stanchion depicted in FIGS. 1 and 2.

FIG. 4 is a schematic side elevational view identical to FIG. 3, with notations to indicate certain preferred dimensions and angles for a specific application.

FIG. 5 is a front perspective view of the stanchion according to FIG. 1, with a muffler supported thereon.

FIG. 6 is a front perspective view analogous to FIGS. 1 and 5, but depicting the stanchion with equipment mounting brackets, but with no equipment thereon.

FIG. 7 is a fragmentary front perspective elevation view analogous to FIG. 1, but depicting the stanchion mounted on a portion of a truck frame.

FIG. 8 is a schematic force diagram for the stanchion shown in FIGS. 1-3.

FIG. 9 is a schematic force diagram for the stanchion shown in FIGS. 1-3.

FIG. 10 is a schematic force diagram for the stanchion shown in FIGS. 1-3.

FIG. 11 is a side elevational view of a second embodiment of a muffler stanchion, according to the present disclosure.

FIG. 12 is an enlarged, fragmentary perspective view of a upper clamp portion of the muffler stanchion depicted in FIG. 11.

FIG. 13 is an enlarged, fragmentary perspective view of a lower clamp portion of the muffler stanchion depicted in FIG. 11.

FIG. 14 is a perspective view of a component of the lower clamp portion depicted in FIG. 13.

FIG. 15 is an enlarged, fragmentary rear perspective view of a lower mount portion of the muffler stanchion depicted in FIG. 11; the portion depicted in FIG. 15 being shown with two internal supports depicted partially exploded from an internal position.

FIG. 16 is a fragmentary view analogous to FIG. 15, taken from a front view.

FIG. 17 is a perspective view the muffler stanchion depicted in FIG. 11, depicted with a vertically mounted muffler supported thereon.

### DETAILED DESCRIPTION

The current disclosure concerns masts or stanchion arrangements. The disclosure particularly concerns masts or stanchions used to support equipment on a vehicle, such as a truck. The stanchions can be used as part of an arrangement or assembly to support a variety of equipment types, for example mufflers and/or air cleaner equipment. The stanchions disclosed herein are particularly well suited for supporting mufflers, especially vertical mufflers.

In general, the mast or stanchion, in use, has one end (a bottom end) mounted on the truck framework and a second end which extends vertically and terminates adjacent a portion of supported equipment such as a muffler. Preferably the muffler stanchion has a relatively small base, bottom or footprint. In typical applications, a perimeter which surrounds all support structure for the stanchion, at the base, would have a size of no greater than about 30 inches (76 cm.), typically no greater than about 24 inches (61 cm.). The term “perimeter” in this context, is meant to refer to a smallest line which would surround, at the base, all support structure for the stanchion, whether spread apart at the base, or joined together at the base. By “base,” “bottom,” or “footprint” and variants thereof, in this context, reference is meant to the bottom most end of the stanchion, in normal use.

The preferred stanchions disclosed herein, can be used with no additional upper support arrangement, such as support rods, upper brackets or upper dampening apparatus. That is, the preferred stanchion arrangement comprises the stanchion with any equipment and necessary brackets mounted directly thereon, and with the only region of supporting attachment to the vehicle framework being in the lower or base portion of the stanchion, preferably directly with the vehicle frame. The terms “upper support rods,” “upper brackets” and “upper dampening apparatus” and variants thereof are meant to refer to any upper support arrangement equipment mounted to engage an upper region of the stanchion, i.e., above the base location whereat the stanchion is bolted to the framework. The term “supporting attachment to the vehicle framework” is meant to refer to the location whereat bolts, brackets or other equipment are used to secure the weight of the stanchion on to the framework of the vehicle. The term is not meant to refer to tubes or other connections which may attach to a muffler supported by the stanchion and which are not configured and designed to support both the stanchion and the muffler weight together.

Typical stanchions according to the present disclosure are utilized to support equipment, such as mufflers, which have a weight of at least 15 pounds (6.8 kg.), typically greater than 20 pounds (9 kg.), not including the weight of brackets. When used to support a muffler, the stanchion will also support the weight of brackets and also exhaust tubes attached to the inlet and exit ends of the muffler.

The typical muffler stanchion will have a vertical height of at least 2 feet (0.6 meter), and a stanchion weight of at least 30 lbs. (13.6 kg.), typically at least 40 lbs. (18.1 kg.).

Typical muffler lengths would exceed 30 inches (0.76 meters), and will be at least 45 inches (1.14 m.), for example between about 45 (0.76 m.) and 65 inches (1.65 m.). Typical mufflers used with stanchions as described herein have diameters of at least 8 inches (20.30 m.), typically 8 to 14 inches (20.3-35.6 cm.).

Stanchions according to preferred embodiments can be configured to manage and support a selected total weight within the range of 50 lbs. to 150 lbs. (22.7-68 kg.) and in some instances above, including the stanchion weight, the muffler weight, heat shield weight, exhaust tube weight and other equipment weights supported by the stanchion. The term “selected total weight within the range . . . ” is meant to indicate at least one weight, for a design, and not necessarily all weights within the range.

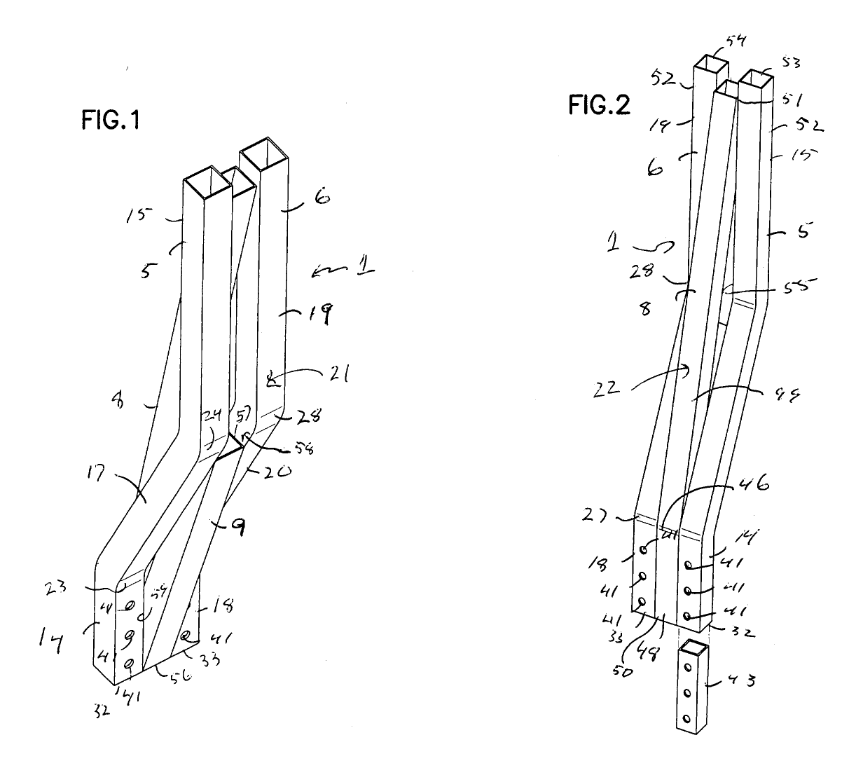

Turning now to the figures, the reference numeral 1, FIG. 1, generally references a stanchion according to the present disclosure. The stanchion 1 of the embodiment depicted comprises a plurality of tubular structural components. Generally, the stanchion 1 includes at least two vertical structural components. The term “vertical structural components” is meant to refer to components which extend upwardly from a vehicle framework, to support a muffler or alternate equipment. The term “tubular” in this context is meant to refer to a component which is hollow, i.e., defines an internal channel extending longitudinally therethrough.

In a typical embodiment, at least two vertical supports are provided, in the presence of additional support structure, typically positioned between the two vertical supports. The additional structure, sometimes referred to as a central support structure, may comprise one or more components.

The particular shapes to the structural components will be chosen based upon such factors as: the particular vehicle framework involved; anticipated vehicle vibration conditions; stanchion weight; and, muffler size and weight. In the figures, some examples preferred for application with certain trucks are provided. However, alternate configurations including a different number of structural tubular components, or a different configuration to those components, are possible. Some general principles relating to choice of components, are provided herein below, after the examples of FIGS. 1-17 are fully described.

The particular stanchion depicted comprises several tubular components, specifically: side pieces or supports 5 and 6; and, a central support structure, in this instance including: first center or long support 8; and, second center or short beam support 9. Variations from tubular may be used in some instances, for example a C- or U-channel instead of could be used for the first center support 9.

In general, for stanchions 1 according to the present disclosure, tubular components for the side supports 5 and 6, and center structure (in this instance two supports 8, 9) will be preferred for weight and strength. For the particular embodiment depicted in FIG. 1, square tubular components are used; that is, each of the tubes 5, 6, 8 and 9 has a generally square cross section (disregarding rounded corners). It will be understood that supports having alternate cross sections, such as circular or rectangular can be used. The square tube components depicted, are meant to be examples. However, being square they do present convenient surfaces for fitting together and welding.

The side components 5 and 6 are each preferably continuous in length, i.e., without sectional seams. Each preferably includes at least two bends therein. For the embodiment shown, each has three sections formed by two bends, namely, for support 5: first or base section or region 14; second extension section or region 15 at an opposite end from the first or base region; and, center region, section or extension 17, which extends between regions 14 and 15; and, for support 6, analogously first or base extension section or region 18; opposite second section, extension or region 19; and, central region, section or extension 20 extending therebetween. Herein, first sections 14, 18 of the side components 5 and 6 respectively, are sometimes referred to as “base regions,” because, in use, these end regions form a base point of attachment between the stanchion 1 and a vehicle frame, as discussed below. The base regions typically extend for a length of 10 inches, or less. The term “bend” is meant to refer to a distortion from linear or straight that does not involve a joint or seam.

Herein, the end regions opposite from the base region, i.e., end regions 15 and 19 of side supports 5 and 6, respectively, are sometimes referred to as “free ends” or “free end regions,” because when the stanchion 1 is mounted on a vehicle frame during preferred use, these regions generally project freely upwardly, except for attachment to supported equipment. That is, they are free (in preferred use) of upper support rods or other upper supports extending to parts of the vehicle, which are not part of the stanchion.

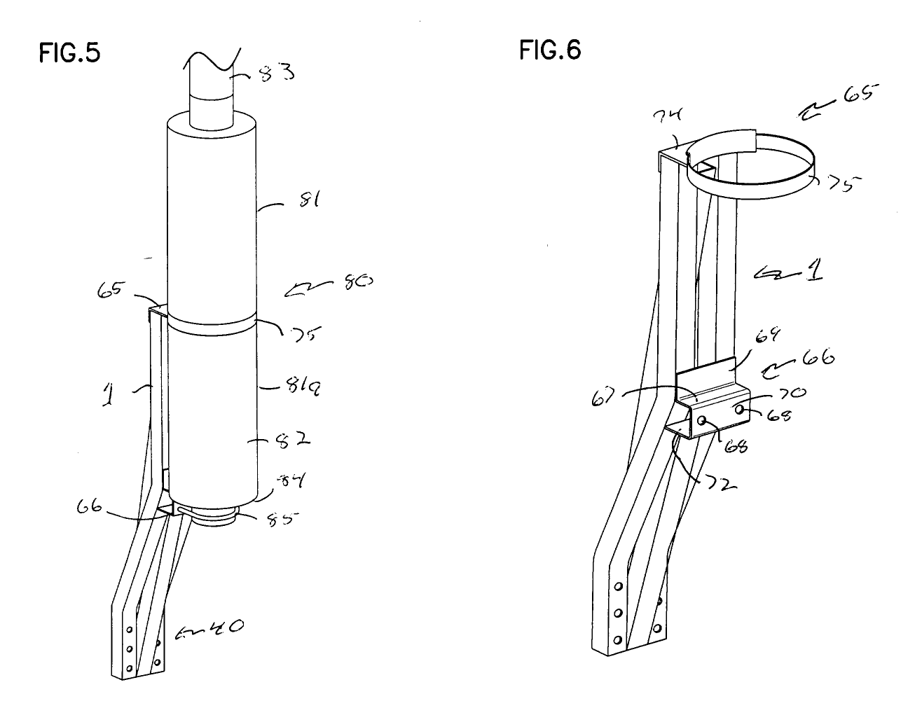

Referring to FIG. 1, the view depicted is generally referred to as a front side perspective, with the side generally facing the viewer, i.e., side 21, being referred to as a front side. In this context, the term “front side” is meant to refer to a side of the stanchion 1 which generally faces equipment to be supported, in use. This can be understood by comparing FIG. 1 and FIG. 5.

Now referring to FIG. 2, the view depicted is generally a back side or rear side perspective view with side 22 generally referring to a side opposite of stanchion 1 from front side 21. In this context the term “rear side” and variants thereof, is meant to refer to a side of stanchion 1 opposite from supported equipment, in use.

For the preferred embodiment depicted in FIG. 1, side supports 5 and 6 are generally identical to each other in shape and size, and are spaced apart with the center supporting structure, in this instance center supports 8 and 9, positioned to extend between them. Of course, in some applications the side supports can be made such that they are not identical.

Referring to FIGS. 1-4, for the particular example embodiment depicted herein, each of the side extensions 5, 6 can be defined as having two bends that specifically provide for an “open z configuration.” By the term “open z configuration” in this context, it is meant that each extension has three straight or relatively straight sections, similar to the letter z, but with the internal angle between each two adjoining sections being greater than 90°. The term “open z” is meant to refer to such a configuration without regard to whether the assembly is configured to display a reverse image of an open z appearance. For the particular embodiment shown, the internal angles of the open z configuration are each about 155°, which is typical for such embodiments. Angles within a range of 110° to 170° can, for example, also be used. It is anticipated that the angle will typically be within the range of 135° to 170°, for preferred muffler stanchions.

For the particular embodiment depicted, each of the side supports 5 and 6 is a continuous tubular structure and is shaped as an open z by having a pair of bends in it. Referring to support 5, FIG. 1, this would comprise bends 23 and 24. As will be seen from the further discussions, preferably bends 23 and 24 are equal and opposite, leaving section 15 extending generally parallel to section 14.

Similarly, support 6, FIG. 2, is preferably a continuous tubular structure having a pair of bends 27 and 28; most preferably with bends 27 and 28 being equal and opposite, to leave section 18 generally parallel to section 19.

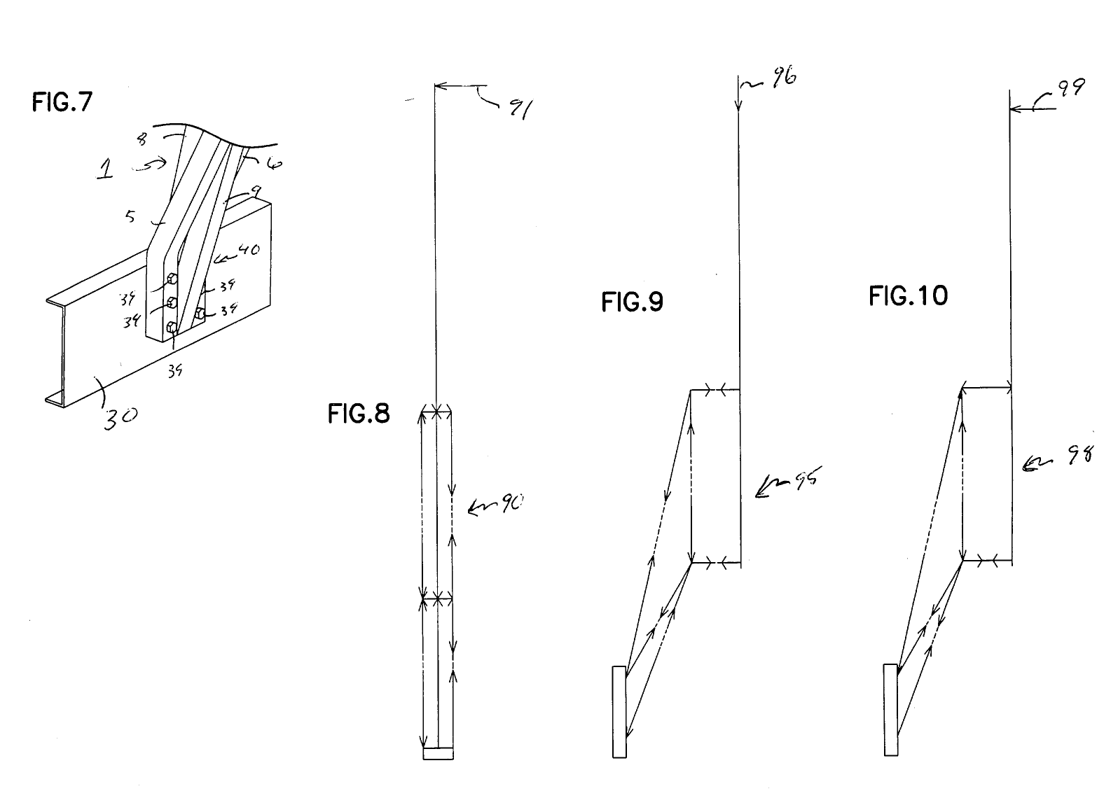

Referring to FIG. 7, the stanchion 1 (shown in fragmentary view) can be mounted on a truck frame 30, by bolts 39 or similar connections, extending through a portion 30 of the truck frame and a base region 40 of the stanchion 1. Bolt holes to allow for this are shown at 41 in FIGS. 1 and 2. For the particular preferred embodiment shown, bolt holes 41 extend through base sections 14 and 18, in each of the side structures 5 and 6, respectively. If desired, the side structures 5 and 6 can be reinforced at these locations, for example by a short tube internally positioned aligned with each pair of holes; or, by a reinforcing section of tubing inserted within the tubular structures 5 and 6, at this location. In FIG. 2, an exploded depiction is shown of such a reinforcing tube 43 associated with side piece 5.

At the location where the stanchion 1 is mounted on the truck frame 30, for example by bolts 39 or similar connections, a lower dampening arrangement or structure, to inhibit vibration transmission from the vehicle frame through the muffler stanchion can be provided. When it is said herein that in preferred locations “upper dampening arrangements” are avoided, it is not meant that no lower dampening arrangement can be used directly between the vehicle frame and the muffler stanchion, where the muffler stanchion is mounted on the vehicle frame. In some applications, muffler stanchions according to the present disclosure can be used without such lower dampening arrangements at the point of attachment, however.

As indicated herein, in general for structures of the type indicated in the figures, in addition to at least two tubular supports, a center structural support or arrangement is provided. For the particular embodiment shown, the center structural support is provided by two component pieces, the first center support 8 and the second center support 9.

Referring to FIGS. 1 and 2, attention is now directed to first center support 8. The first center support 8 is also preferably tubular and preferably has at least one bend. In the example shown, it has one bend that defines an “open L configuration.” By the term “open L configuration” in this context, it is meant that preferably first center support 8 has a L configuration, with the internal angle greater than 90°. The term “open L” in this context is meant to refer to such a configuration even if viewed from a direction presenting the mirror image of an open L. For the particular embodiment depicted the internal angle of the open L is about 169.2°, which is typical for a preferred embodiment. Generally, angles in the range of 145° to 178° can, alternatively, be used, for example. It is anticipated that the angle will typically be within the range of 155° to 175°, for preferred muffler stanchions.

The center support 8 depicted is continuous with one bend 46, FIG. 2, which forms base region 48 and opposite extension 49. Preferably it is mounted in the muffler stanchion 1 such that a bottom edge 50 of base 48 is generally flush with bottom ends 32 and 33 of side pieces 5 and 6 respectively, and such that base 48 extends parallel to base regions 14, 18. Opposite end 49 of first center support 8 generally extends to a position 51 between side supports 5 and 6 in an upper half 52 of extensions 15 and 19. Alternately stated, end 49, of first center support 8, typically extends to a position 51 located adjacent ends 53, 54 side sections 5 and 6 respectively, but not necessarily to a position flush with ends 53, 54. For example, section 49 of center section 8 extends to an end 51 in a half of section 15 and 19 (of side sections 5 and 6 respectively), located adjacent ends 53 and 54, most preferably to a location within 4 inches (10.2 cm.) of ends 53 and 54.

A reason for referred extension of portion 49 of section 8, into the region defined, is that, in general, center section 8 provides for support to upper end movement of the stanchion 1, in use. Referring to FIGS. 1 and 2, in general center section 8 can be viewed as a “back side” diagonal support, in that its extension, i.e., the extension of section 49, in stanchion 1, is such that it projects outwardly from the back side 22, relative to portions 15, 17 and 19, 20 of side sections 5 and 6, respectively. This projection is represented in FIGS. 2 and 3 at gap 55.

The supports 5, 6 and 8 would typically be welded to one another, at convenient locations in both the base regions and adjacent the free ends.

Attention is now directed to second center support 9, FIG. 1. As indicated above, preferably second center support is tubular. The second support 9 is preferably straight, i.e., has no bends, in extension between base end 56 and opposite end 57. Preferably the second center support 9 is mounted in the stanchion 1 such that base end 56 engages the base region 48 of the first center support 8, and most preferably such that it is flush with bottom ends 32, 33 of the side supports 5 and 6, and such that opposite end 57 extends up into a region 58 positioned between sections 5 and 6, in a center one-third of the longitudinal extension thereof, most preferably into a region adjacent or within 4 inches of upper bends 24 and 28. The term “upper” in this context, is meant to refer to bends 24, 28 located furthest from base ends 32, 33 respectively, or, alternately stated, which are uppermost when stanchion 1 is mounted for use. Most preferably end 57 of section 9 terminates at about a location about where bends 24 and 28 start, from sections 17 and 20 respectively.

Referring to FIGS. 1 and 3, to facilitate assembly, base region 54 of second center support 9 is provided with bevel cut at 59. The bevel cut 59 provides for a convenient surface of engagement between second center piece 9 and a corresponding base region 48 of first center piece 8; and, a surface toward which compression forces downwardly on support 9, in use, are directed.

When configured in the manner shown, generally section 9 can be referred to as a “short beam” support or section. In general, section 9 provides support for much of the weight carried by this stanchion 1, when assembled on a vehicle for use. This will be understood from more detailed discussion below, in connection with assembly diagrams and force diagrams.

A usable material for the various pieces 5, 6, 8 and 9 is tubular steel, typically commercial carbon steel. One usable material would be ASTM A513, Grade B, steel. Again, the four tubes 5, 6, 8 and 9 can be secured together by welding.

For the particular embodiment depicted in the figures, the tubular components 5, 6, 8 and 9 are each square components, i.e., each has a square cross-section. One usable cross-section is a two-inch square (5 cm. square) cross-section. By “two-inch square” in this context it is meant that the square is two inches by two inches (outside) in size. In an alternate definition, each tubular component can be characterized as having a cross-sectional outside perimeter size. Preferably, the cross-sectional outside perimeter size of each one of the tubular components is within the range of 5-12 inches (12.7 cm.-30.5 cm.). A two inch square (5 cm. square) tube, of course, would have an outer cross-sectional perimeter size of 8 inches (4 times 2 inches) (or 20 cm.—i.e., 4×5 cm.). For preferred embodiments, all four tubes 5, 6, 8 and 9 have the same outside perimeter size.

A usable material would be steel having a thickness of about one-eighth inch (0.31 cm.). With such a thickness, and using two inch square material, the total stanchion weight, for a typical vehicle stanchion to support a 45 inches or longer (1.14 m. or longer) muffler, would be about 40-50 pounds (18.1-22.7 kg.). It can be lightened somewhat, by using thinner steel for some or all of the pieces, changing tube size, or by cutting apertures in one or more of the structural components.

Attention is now directed to FIG. 6, which shows equipment brackets mounted on various ones of the supports 5, 6, 8 and 9, for supporting equipment in use. In typical use, the brackets will be chosen for the type of equipment to be supported, and may be customized for specific equipment. Indeed it is an advantage of the configuration of stanchion 1, that it can be conveniently used to support a variety of bracket sizes, shapes and weights.

In general, for a typical application especially to support a muffler or similar equipment, two brackets are used: an upper bracket 65, and a lower shelf bracket 66. In general the shelf bracket 66 is positioned to support much of the weight of the supported equipment (for example a muffler) by having a portion of the equipment (for example a muffler) resting on shelf 67. The shelf bracket 66 may also preferably include holes 68 therein, when used to support a muffler, for mounting of a U-bolt bracket or similar construction, to support the inlet end of the muffler.

The particular shelf bracket 66 shown, comprises a single piece of steel which has been bent appropriately to form: a mounting extension 69, which can be welded to a remainder of stanchion 1; shelf 67, a surface 70 including holes 68 for engagement with a U-bolt bracket 71; and, a lower extension 72, which also engages a remainder of the stanchion 1 and is welded or otherwise attached thereto. Alternately stated, the bracket 66 preferably comprises a single integral piece of steel which is bent to provide: two areas of engagement or attachment to the stanchion 1, for example by welding; a support surface which, in use, will extend generally horizontally (i.e., generally perpendicular to a portion of stanchion 1 on which it is mounted), for supporting a weight of a piece of equipment held in position by the stanchion 1; and, a surface generally perpendicular to the support surface, for attachment of bolts of other bracket equipment.

In general, the upper bracket 65 comprises a support 74 secured to a remainder of the stanchion 1, for example by welding, and an adjustable part 75, which can be secured around the outer circumference of equipment such as a muffler.

The upper bracket 65, for the preferred embodiment shown, is a band bracket, and is generally positioned and configured to inhibit tipping or wobbling of equipment supported by stanchion 1, as opposed to being positioned to substantially support a majority of the downward weight of the equipment. As a result, a band bracket configuration will, in many instances, be convenient for the upper bracket, especially with round equipment such as mufflers.

Attention is now directed to FIG. 5. In FIG. 5 an equipment assembly 80 (or stanchion arrangement) is shown comprising: stanchion 1; and equipment 81, specifically a muffler arrangement 81a mounted thereon. The muffler arrangement 81a generally comprises muffler 82 and exhaust stack 83. The muffler 82 is mounted on the stanchion 1 by having inlet end 84 rest upon shelf 67. The muffler 82 is also secured by U-bolt 85. The muffler 82 is also secured by upper band bracket 65. Preferably the muffler 82 and band bracket 65 are positioned so that the band 65 is aligned with an internal baffle or other support in the muffler 83.

It is noted that in typical use, the only mounting of the assembly 80, and the only support for the assembly 80 on a vehicle, would be through the engagement between the truck frame 30 and the base region 40 of the stanchion 1, FIG. 7. There are not, for the preferred embodiment, any upper supports, upper dampeners, upper tie rods, etc. providing additional support to the assembly 80. The mounting of the stanchion 1 on the truck frame 30 can be a direct metal-to-metal mounting or contact between the stanchion 1 and the truck frame 30, with no dampener therebetween, if desired. A dampener at this location could be used, however.

In FIG. 7, the assembly 80 is mounted “outboard;” meaning that it is on a side of frame 30 directed outwardly from a center of the corresponding vehicle. The principles disclosed herein could be applied to an oppositely, inwardly directed, or “inboard” mounted stanchion arrangement.

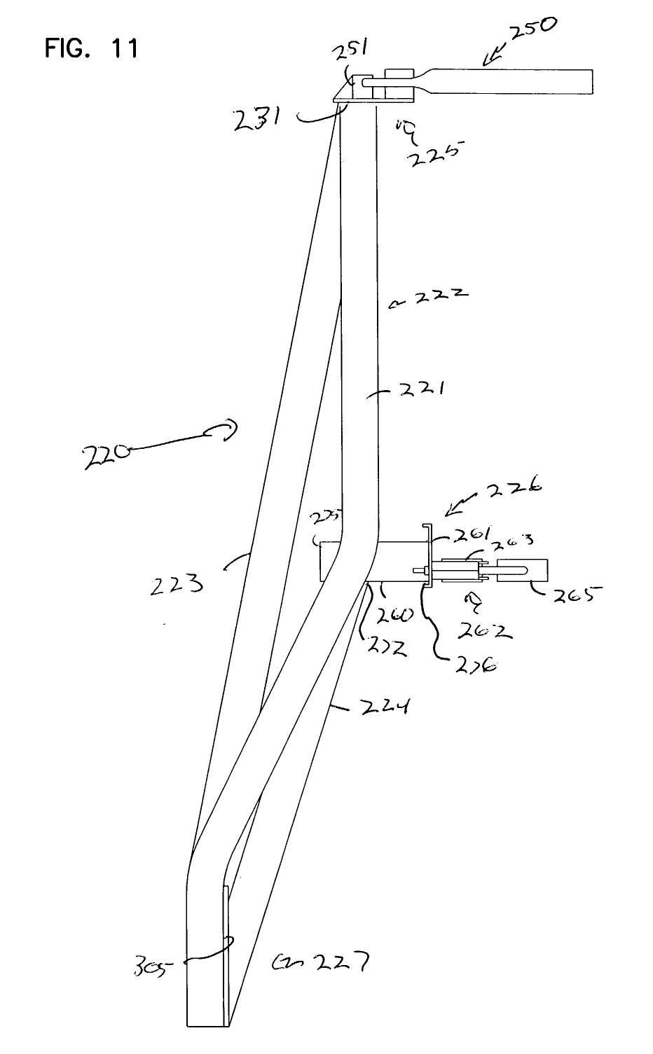

Attention is now directed to FIGS. 8, 9 and 10, which are schematic force diagrams indicating portions of the arrangement under compression or extension, with respect to various forces. Referring to FIG. 8, a force diagram is depicted which indicates stanchion 90 (from front to rear) when subjected, at the top of a supported muffler, to force in the direction of arrow 91. The various arrows indicate which portions of the assembly 90 are under stress in tension (double headed arrow with arrows in opposite directions, i.e., ←→), and which portions are under compression (arrows pointed toward one another, i.e., →←). In FIG. 9 a similar sketch is shown of assembly 95 (from a side) when subjected to force in the direction of arrow 96; and in FIG. 10 a similar schematic is depicted of arrangement 98 (from a side) when subjected to force in the direction of arrow 99. From the force diagrams in FIGS. 8, 9 and 10, it can be understood that the stanchion 1 is efficient and strong with respect to supporting a equipment under various forces of stress. In general, it can be said that the structure is such that there is a variable moment of inertia at different cross-sectional locations in the stanchion.

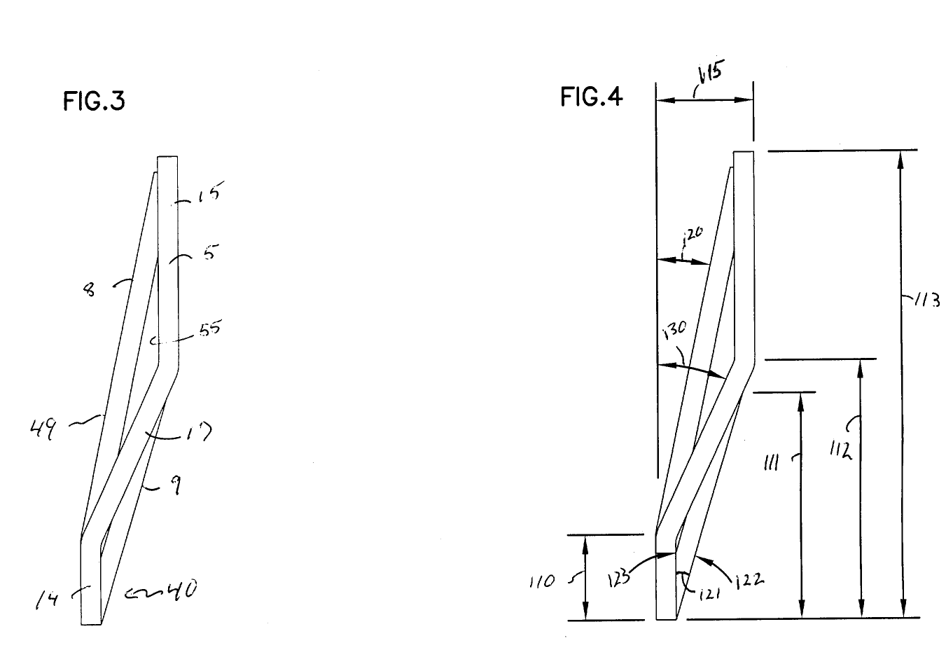

Attention is now directed to FIG. 4. In FIG. 4 some dimensions and angles are shown for a particular stanchion configuration usable, for example, to support a muffler having a length of 45 to 65 inches (1.14 m.-1.65 m.), a weight of about 33 lbs. (15 kg.), an additional stack weight of about 17 lbs. (7.7 kg.) and an additional stack length of about 60 inches (1.52 m.). For a specific example of the embodiment of FIG. 4, each of the four support tubes would have a two inch square (5 cm. square) configuration. In referring to FIG. 4, dimension 110 would be about 7 inches (17.8 cm.), dimension 111 about 22.4 inches (56.9 cm.), dimension 112 about 25.8 inches (65.5 cm.) and dimension 113 about 45.9 inches (1.166 m.).

Dimension 115 would be about 9.8 inches (24.9 cm.). Dimension 115 represents the amount offset from the truck frame or the mounting point on the truck frame, that the muffler bracket and muffler are supported. Thus for the particular embodiment shown in FIG. 4, the muffler would be supported, laterally from the truck frame, a distance of at least 9 inches (22.9 cm.). The actual dimension would be greater than 9.8 inches (24.9 cm.), since the muffler bracket would take up some lateral space as well. It is a characteristic of stanchions according to the present disclosure that they can in some application, be used to support equipment off set, for example, from a direct center of a base of the stanchion by more than 7 inches (17.8 cm.), for example, but not intending to be limiting with respect to the broad concept, within the range of 7 to 27 inches (17.8-68.6 cm.).

Angle 120 is the angle, from vertical, of extension of section 49 of first center support 8. Angle 120, for the particular arrangement shown, is about 11.8°. In alternate embodiments it may be varied, for example, but not intending to be limiting with respect to the broad concept, from 2° to 35°. Angle 121, between lines 122 and 123, represents the angle, from vertical, of the extension of second center support 9. For the preferred embodiment shown, the angle is about 16.6°. In alternate applications it may be varied, for example from 5° to 45°. Thus, for the preferred embodiment, section 49 of first center piece 8, does not extend parallel to second center support 9. Indeed preferably in extension toward vertical in use, the two (sections 49 and support 9) diverge from one another, preferably in direction upwardly, by an angle of at least 3°, and for the particular arrangement shown about 4.8°. This is advantageous, for providing structural rigidity and resistance to problems from vibration. (The term “vertical” in these descriptions or in similar contexts is meant to refer to an orientation of use of the typical stanchion 1 with base region 40 down.)

For the particular embodiment shown in FIG. 4, angle 130, which represents angle from vertical of the extension of center section 17 and 20 of pieces 5 and 6 respectively, is about 25°, again resulting in a diversion (diversion angle of at least 10°, the one shown being about 13.2°) with respect to section 49 of center piece 8. In alternate embodiments, the angle 130 may be varied, for example, from 10° to 80°.

The dimensions and angles provided in the previous paragraph provide examples of particular preferred stanchion 1. Variations can be made, depending upon the application of use.

Above it was discussed that a usable steel for the tubular components 5, 6, 8 and 9 is a steel having a thickness of ⅛ inch, i.e., 0.125 inch (or 0.32 cm.). It is noted that if it is desired to provide the stanchion 1 with lighter weight, thinner steel can be used for one or more of the components. As an example, components having a thickness of at least 0.07 inch (0.18 cm.), for example 0.083 inch (0.021 cm.), can be used. The lower level on useable thickness is generally a matter of strength needed for operation, and will depend on stanchion size, weight and equipment size and weight. Of course the upper level on thickness is primarily controlled by size and weight, and typically it will be less than 0.14 inches (0.36 cm.). (The wall thickness discussed in this paragraph is meant to disregard additional thickness added in the base region, for example by an insert such as insert 43, FIG. 2, in the side supports to facilitate mounting.)

With respect to a particular application to support significant weight on a moving vehicle such as a class 8 truck, the stanchion configuration presented is highly advantageous with respect to its natural resonance frequency. In particular, a significant (and by significant what is meant is relatively long, i.e., greater than four feet or 1.22 m.); and heavy, (i.e., greater than 60 lbs. or 27.2 kg.) component mounted on a truck frame would preferably not have a construction which exhibits a natural resonance frequency of between 8 and 12 hz., since at such a frequency, in some instances, the structure could become excited during operation of the truck, leading to damage of the equipment or undo stress. Indeed it is preferable that the stanchion be configured such that with a muffler mounted thereon, in place for operation, it exhibits a natural resonance frequency of at least 10 hz., in some instances no less than about 13 hz. and, depending on the application, preferably no less than 13.5 hz. It has been determined that the particular stanchion depicted in FIG. 4, for example when made with the dimensions indicated and from 2 inch square (5 cm. square) steel tubes of ⅛ inch (0.32 cm.) thickness, in combination with a muffler, as mounted, exhibits a natural resonance frequency, when mounted on a rigid frame and mount, of approximately 16 hz. This is highly advantageous for a stanchion structure with a muffler, on truck such as class 8 trucks. It is also unique with respect to many previous constructions, since stability is accomplished without the use of an upper tie-rod, upper dampening arrangement or (more generally stated) additional upper support structure. It is noted that lessening thickness of the tubes of some of the components will generally reduce the natural resonance frequency. However reducing three of the four tubes to a thickness of 0.083 inches (0.21 cm.) has been observed to lead to reduction in natural resonance frequency, when mounted on a rigid frame and mount, of only to about 13.5 hz. This is preferably achieved with a stanchion arrangement which, in combination with clamps mounted thereon, has a weight of no greater than about 60 lbs. (27.2 kg.). (The stanchion without the clamps typically has a weight of no greater than 55 lbs. or 24.9 kg.) Again, in general it can be said that the structure is such that there is a variable moment of inertia at different cross-sectional locations in the stanchion.

It is an advantage, then, that the principles disclosed can be applied to provide a stanchion which, in association with equipment such as a muffler or muffler assembly, can provide the following: (a) the stanchion, preferably as defined, rigidly mounted at one end to the frame only in a base region and without the use of upper dampening arrangements or upper tie-rods; (b) a support by the stanchion, of a muffler assembly weight of in excess of 33 lbs. (15 kg.), and typically on the order of 40-60 lbs. (18.1-27.2 kg.); (c) a natural resonance, installed, of preferably no less than 10 hz., typically no less than 13 hz.; and, (d) a stanchion weight, not counting brackets and equipment mounted thereon, of not greater than about 50 lbs (22.7 kg.).

In FIGS. 11-17, in a second embodiment of a muffler stanchion according to the present disclosure is provided herein. Referring to FIG. 11, reference numeral 220 general identifies the muffler stanchion. The muffler stanchion may be generally as described herein above for the arrangement of FIGS. 1-10, except modified as described. Thus, it may be constructed with the variations discussed with respect to FIGS. 1-10, although a specific example is shown.

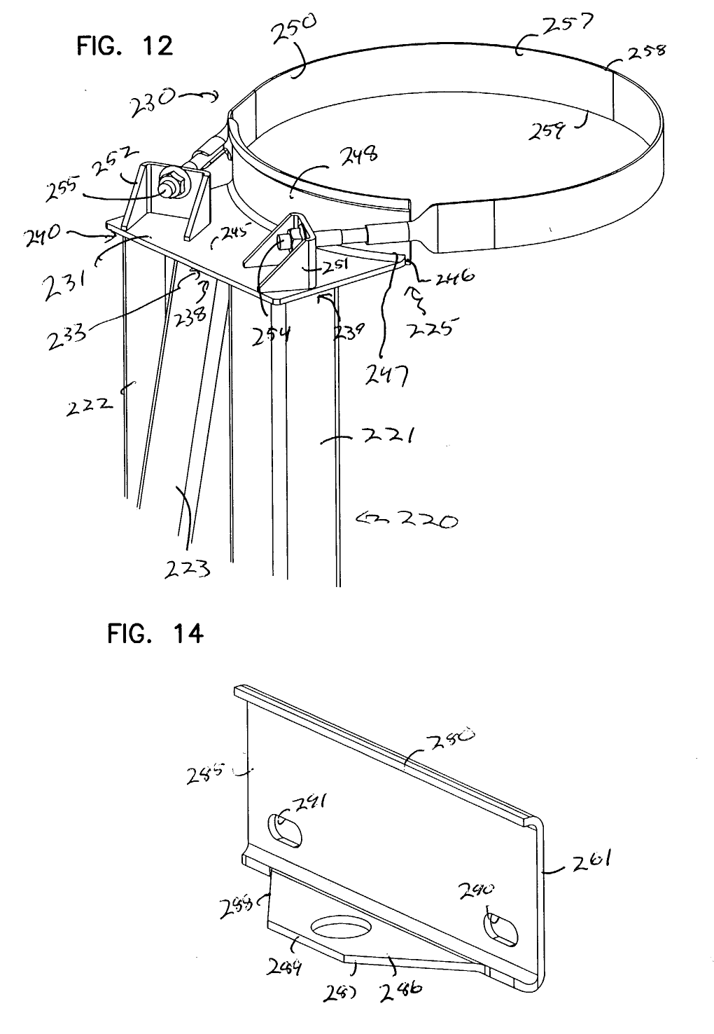

The stanchion 220 depicted comprises four tubular structural components, namely: first and second, open Z configuration, side supports 221, 222, a first, open L configuration, center support 223; and, second, straight center support 224. (Support 222 is not viewable in FIG. 11, see FIG. 12.) The muffler stanchion 220 differs from muffler stanchion 1, primarily with respect to: features at or in the vicinity of an upper muffler clamp portion 225; features at or in the vicinity of a lower, shelf, muffler clamp portion 226; and features at or in the vicinity of a lower mount or base portion 227.

Attention is first directed to features at or in the vicinity of the upper clamp portion 225. Referring to FIG. 12, the upper clamp portion 225 includes a circular clamp construction 230, a mounting plate 231, and an upper portion 233 of three of the four stanchion tubes, in particular side, open z, tubes 221, 222 and open L center tube 223.

The mounting plate 231 is mounted on top of tubes 221, 222 and 223 for example by welding. To facilitate this, tube 223 is modified from tube 8, FIG. 3. In particular, at end 238 tube 223 is preferably extended and bevel cut to be substantially even with tops 239, 240 of tubes 221, 222, respectively, to provide a large, convenient, mounting surface for plate 231.

In general, plate 231 includes base portion 245 having a front edge 246 defining a curved surface, preferably curved (concave) surface 247. Preferably the curved surface 247 is radiused at about the same radius as a muffler to be secured by clamp 230. Mounted on surface 247 is included a surface strip 248, for supporting a muffler. The curved strip 248 is preferably a metal component welded or otherwise secured against surface 247. The strip 248 will typically be about 1 inch to 2 inch high (2.5-5 cm. high) by 5 inch to 8 inch long (12.7 to 20.3 cm.). A typical plate 231 will be about 5 inch to 8 inch (12.7-20.3 cm.) by 3 inch to 6 inch (7.6 cm.-15.7 cm.), with a curved edge radiused at 4 inch to 7 inches (10.1-17.8 cm.)

A band clamp 250 is positioned mounted on brackets 251 and 252. The brackets 251, 252 are preferably secured to base plate 245, projecting upwardly, in this instance in the same direction as flange 248. The band clamp 250 includes opposite threaded ends 254, 255, secured to brackets 251 and 252 respectively. The band clamp 250 further includes a strip portion 257. The strip 257 is preferably about 1 inch to 2 inch wide (2.5-5 cm.) (i.e., the distance between opposite edges 258 and 259). It is preferably made from aluminized steel.

The clamp arrangement 230 provides for a more secure mounting around a muffler, than an arrangement analogous to that shown at 75, FIG. 6. A reason is that the configuration of the arrangement 230 is less likely to break, since it more closely conforms to an outer shape of a typical muffler body.

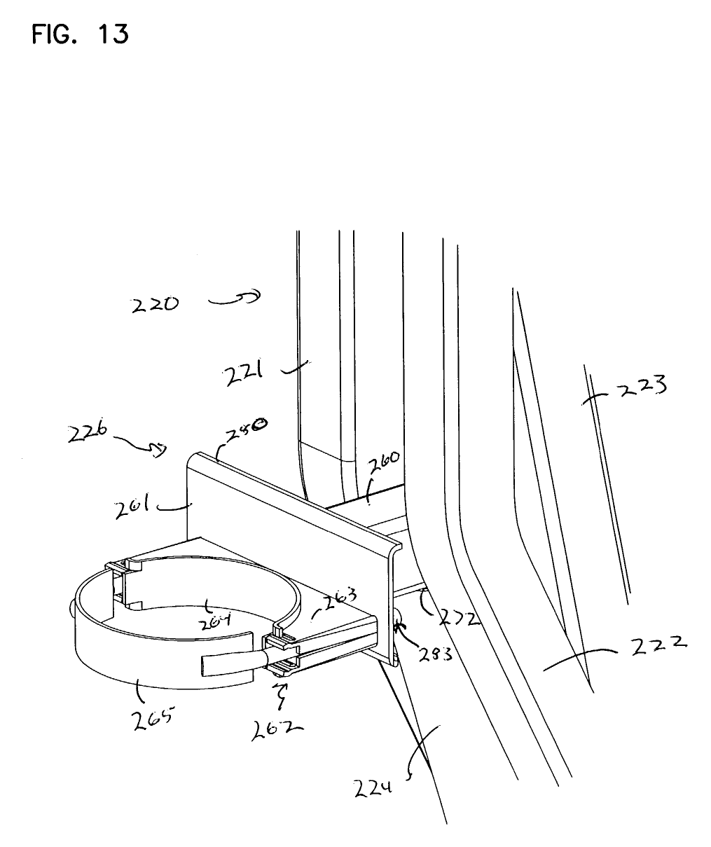

As indicated above with respect to FIG. 11, a second area of difference from the arrangement shown in FIGS. 1-7, is with respect to the lower clamp portion 226. This portion is shown in detail in FIGS. 13 and 14. Referring to FIG. 13, the preferred clamp portion 226 is a shelf clamp that generally includes: stub tube or mount 260, plate 261, and u-clamp arrangement 262, comprising base 263, curved shim 264, and curved u-clamp 265.

Referring to FIG. 13, as an example tube 260 could comprise a ⅛ inch (0.31 cm.) thick steel, two inch square (5 cm. square), tube mounted on upper end 272 of center tube 224, between outer open z tubes 221, 222, although variants (for example tubes each having perimeters within the preferred range of 5-12 inches (or 12.7-30.5 cm.) are possible. (The upper end 272 of center tube 224 could be bevel cut, to provide an appropriate attachment surface.) The specific vertical location, and distance from upper clamp 225, will be determined by the particular muffler to be mounted. In general the center tube 224 can be selectively positioned further up, or down, a little in the configuration of the stanchion 220 to provide preferred positioning of the clamp assembly 226.

The tube 260, FIG. 11, has opposite inner and outer ends 275, 276. The extent to which outer end 276 projects outwardly from between tubes 221, 222, is a matter of choice based upon what will be required to obtain a substantially vertical mount for a secured muffler.

Turning again to FIG. 13, mounted on tube 260 (at end 276, FIG. 11), is provided plate 261. The plate 261 includes an upper shelf 280, in the example shown comprising a curved portion the plate 261, in this instance bent direction toward tubes 221, 222. Shelf portion 280 is a shelf portion on which part of a muffler will rest, during mounting. This is shown and discussed below in connection with FIG. 17.

Still referring to FIG. 13, u-clamp arrangement 262 is shown mounted on plate 261. It is adjustable to tighten around an inlet tube portion of a secured muffler. Tightening can be accomplished with nuts on opposite ends of the u-clamp 265, one being located at 283, FIG. 13.

Attention is directed to FIG. 14 which shows plate 261. Plate 261 not only includes a vertical portion 285 and upper shelf 280, but also a rearward projecting flange 286 having opposite inwardly tapered edges 287, 288, directed toward inner edge 289. This shape accommodates mounting on tube 260 while at the same time convenient operation of tightening nuts on u-clamp 265. The plate 261, FIG. 14, is shown with oval apertures 290, 291 therein positioned to accommodate adjustable positioning of the clamp arrangement 262, FIG. 13. The plate 261 will preferably be formed as a single integral piece, for example of metal such as steel.

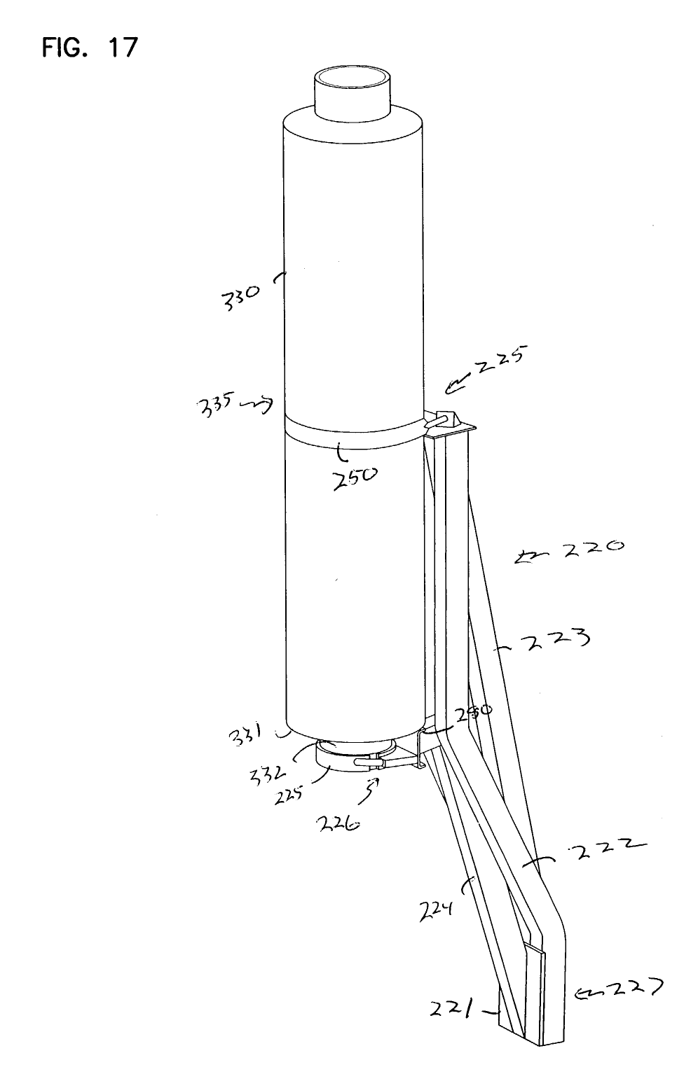

Attention is now directed to FIGS. 16 and 17, in which the lower mounting or base portion 227 of the muffler stanchion 220, FIG. 11, is depicted. Referring to FIG. 16, at lower ends 300, 301 of tubes 221, 222, a strengthening or reinforcing plate 305 is mounted. The plate 305 is secured to tubes 221, 222, with a center portion 306 extending over center tube 224. Thus, plate 305 has a u-shape. Apertures 307 in plate 305 provide for mounting bolts to extend through the tubes 221, 222.

Tube inserts, for reinforcement, are depicted partially removed (or exploded) from ends 300 and 301 at 310, 311 respectively. The tube inserts 310, 311 each preferably comprise a three sided construction having a u-shape. The inserts 310, 311, in use, are positioned within tubes 221, 222, to reinforce them.

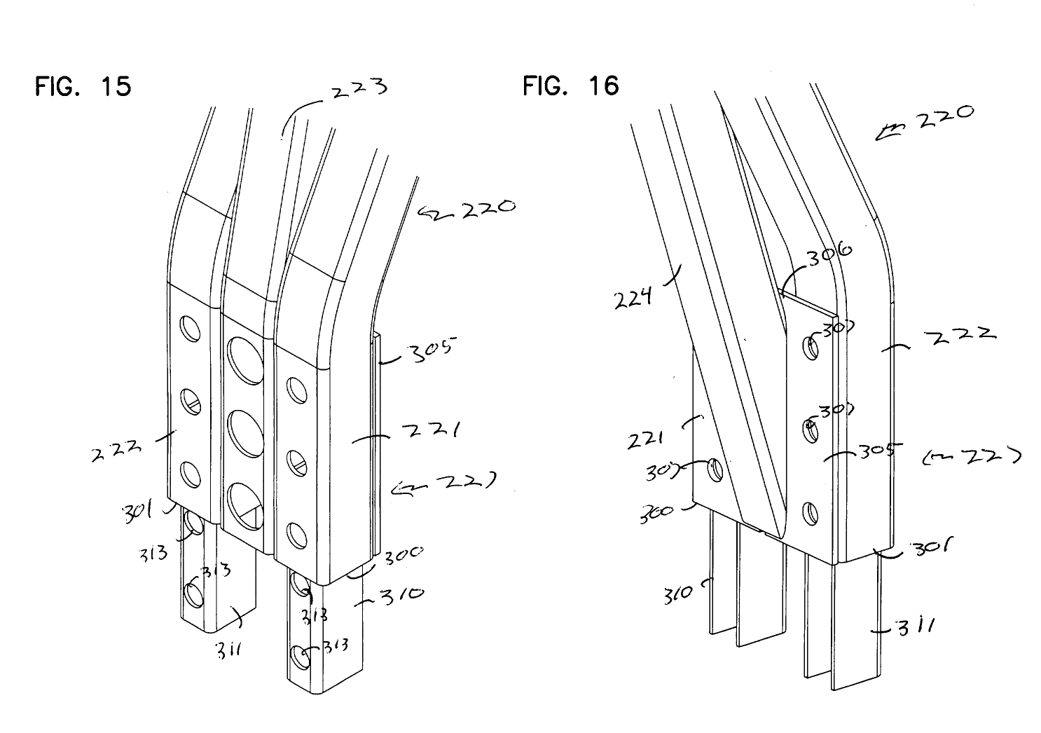

Referring to FIG. 15, an opposite portion of tube inserts 311, 310 from that viewable in FIG. 16 can be seen. It is noted that the tube inserts 310, 311 have apertures 313 therein, to accommodate bolts projected through corresponding portions of tubes 221, 222.

As a result of the reinforcing plate 305, and the inserts 310, 311, the mounting portion 227 of the muffler stanchion 220 is strongly reinforced.

Attention is now directed to FIG. 17, in which a muffler 330 is shown mounted on a muffler stanchion 220 in accord with FIGS. 11-16. A lower outer edge 331 of a muffler body is shown resting upon shelf 280, with the muffler outlet tube 332 secured by u-clamp 265. At a central portion 335 of the muffler 330, clamp 250 extends around the muffler, to secure it in place. No added upper tie-rods, supports or dampeners are used.

Preferably the positions of the clamps 250 and 226, vertically and laterally, are fixed so that the muffler 330 will be mounted substantially vertically.

For the embodiment shown in FIGS. 11-17, typically the weight of the stanchion and various clamp arrangements thereon, is about 52 lbs. (23.6 kg.), with the weight of the stanchion not having any clamp arrangements thereon being about 47 lbs. (21.3 kg.). Each tube of the stanchion would preferably be ⅛ inch thick (0.31 cm.), ASTM A500 Grade B steel. Each of the two u-tube reinforcement inserts would be carbon steel, for example structural quality steel HRP&O ASTM A36. The reinforcement plate 305, would typically be carbon steel, such as 3/16 inch (0.48 cm.) structural quality steel HRP&O ASTM A36.

Methods of mounting stanchions and equipment using principles as disclosed herein should be apparent from the above and the drawings.

The techniques of the present disclosure relate to the utilization of two or more tubular members in a stanchion or mast arranged in such a way as to provide sufficient flexural rigidity, dampening and control of motion due to vehicular vibration input loads, to provide for a stable equipment support, such as muffler support, even in the absence of upper tie rod, upper support or upper dampening structure. These at least two tubular members, in some applications, could be supported with central structural support therebetween.

In general terms, flexural rigidity is achieved by arranging the members to achieve a moment of inertia sufficient to preferably achieve a first natural frequency of at least 10 hz., typically at least 13 hz., and in some instances at least 13.5 hz. when supporting a muffler and accessories to provide a total weight (muffler plus stanchion plus accessories) at a selected weight within a range of 50 lbs.-100 lbs. (22.7-45.4 kg.), while being connected at a base mount, typically rigidly mounted (and even without a lower dampener).

The term “moment of inertia” used herein, is meant to refer to the mathematical term commonly used to mechanics, to characterize flexural rigidity of a collection of connecting members, due to geometry.

Of course constructions using the principles described herein can be designed based on selecting various tubular components, and securing them together, with testing. However, an effective approach to design is to use a finite element analysis. Using such computer tools, one can provide a geometry and material properties, and can simulate performance to determine a natural frequency for the structure.

The above-referenced materials and dimensions are meant to be exemplary, of certain preferred embodiments. The principles disclosed can be applied in a variety of sizes and shapes, and with a variety of alternate materials.

We claim:

1. A stanchion arrangement for supporting equipment on a vehicle; said stanchion comprising:
(a) at least two upright tubular supports comprising a first and a second tubular support;
(i) each of said first and second tubular supports having at least two bends therein;
(b) said stanchion defining a mounting base having a base perimeter size of no greater than 30 inches.

2. A stanchion arrangement according to claim 1 including:
(a) a center support arrangement positioned between the first and second tubular supports.

3. A stanchion arrangement according to claim 2 wherein:
(a) each one of the first and second side supports has an open z-configuration defining: a base region; an opposite free end region; and, a central region.

4. A stanchion arrangement according to claim 3 wherein:
(a) the center support arrangement includes a first center support and a second center support.

5. A stanchion arrangement according to claim 4 wherein:
(a) the first center support is a back side support having:
(i) a base region oriented adjacent said base regions of said first and second side supports; and,
(ii) an opposite free end region oriented adjacent said free end regions of said first and second side supports.

6. A stanchion arrangement according to claim 5 wherein:
(a) the second center support is a front side support having first and second opposite ends;
(i) the first end of the second center support being secured in the stanchion at a location adjacent the base regions of the first and second side supports; and
(ii) the second end of the second center support being positioned between the first and second side supports in the central regions of the first and second side supports.

7. A stanchion arrangement according to claim 6 wherein:
(a) the first center support has an open L configuration.

8. A stanchion arrangement according to claim 7 wherein:
(a) the first center support is tubular; and
(b) said second center support is tubular.

9. A stanchion arrangement according to claim 8 wherein:
(a) each one of said first and second side supports, said first center support and said second center support has a square cross-section.

10. A stanchion arrangement according to claim 9 wherein:
(a) said first and second side supports each have an outside, cross-sectional, perimeter within the range of 5-12 inches;
(b) said first center support has an outside cross-sectional, perimeter definition within the range of 5-12 inches, inclusive;
(c) said second center support is tubular and has an outside, cross-sectional perimeter definition within the range of 5-12 inches, inclusive; and
(d) the stanchion has a mounting base with a perimeter size of no greater than 24 inches.

11. A stanchion arrangement according to claim 8 wherein:
(a) said base regions of said first end second side supports each include a re-enforcing insert therein.

12. A stanchion arrangement according to claim 11 wherein:
(a) each reinforcing insert is a u-tube.

13. A stanchion arrangement according to claim 8 wherein:
(a) a portion of said first center support extending between said base region and said free end diverges from said second center support.

14. A stanchion arrangement according to claim 13 wherein:
(a) said portion of said first center support extending between said base region and said free end has a divergence angle of at least 3°, relative to said second center support.

15. A stanchion arrangement according to claim 8 including:
(a) a reinforcement plate mounted on said first and second side supports in said base region; said reinforcement plate including a center portion extending over said second center support.

16. A stanchion arrangement according to claim 8 having:
(a) a muffler mounted on the stanchion.

17. A stanchion arrangement according to claim 16 wherein:
(a) the muffler has a length of at least 45 inches and a weight of at least 20 lbs.; and
(b) the stanchion has a weight of at least 20 lbs.

18. A stanchion arrangement according to claim 17:
(a) mounted on a frame member of a truck with the muffler oriented vertically, and without any upper support arrangement.

19. A method of mounting supporting equipment on a vehicle frame and in a vertical orientation; said method comprising steps of:
(a) attaching a stanchion arrangement including at least two tubular support members to frame piece of a truck by bolts located in a base region of the stanchion; and
(b) supporting, on the stanchion, equipment including a muffler having a length of at least 45 inches and a weight of at least 20 lbs., without any upper tie-rods, upper supports or upper dampeners.

20. A stanchion arrangement assembly comprising:
(a) at least two tubular support members;
(b) a supported muffler;
(c) a selected total stanchion arrangement and muffler weight within the range of 50 to 150 lbs.; and,
(d) a first natural resonance of at least 10 hz.

21. A stanchion arrangement for supporting equipment on a vehicle; said stanchion comprising:
(a) at least two upright tubular supports comprising a first and a second tubular support;
(ii) each one of the first and second side supports having an open z-configuration defining: a base region; an opposite free end region; and, a central region; and,
(b) a center support arrangement positioned between the first and second tubular supports; the center support arrangement including a first center support and a second center support.
(i) the first center support being a back side support having: a base region oriented adjacent said base regions of said first and second side supports; and, an opposite free end region oriented adjacent said free end regions of said first and second side supports;
(ii) the second center support being a front side support having first and second opposite ends; the first end of the second center support being secured in the stanchion at a location adjacent the base regions of the first and second side supports; and, the second end of the second center support being positioned between the first and second side supports in the central regions of the first and second side supports;
(c) said stanchion having a base region defining an outside, bottom, perimeter of no greater than 30 inches.
